(19) United States
(12) Patent Application Publication
(10) Pub. No.: US 2002/0116230 A1
(43) Pub. Date: Aug. 22, 2002

(54) Savings plan and insurance policy for it for after-life private web sites

(76) Inventor: Sang K. Sheem, Alameda County, CA (US)

Correspondence Address: Sang K. Sheem, 1790 Paseo Del Cajon, Pleasanton, CA, 94566, US

(21) Appl. No.: 09/791,913

(22) Filed: Feb. 22, 2001

(51) Int. Cl. G06F 17/60

(52) U.S. Cl. 705/4

(57) ABSTRACT

A savings plan is devised to prepare a fund to operate a private web site after the host of the web site dies. In order to lessen the financial burden, regular deposits over an extended period are configured. An insurance feature could be built in the saving plan in order to prevent a failure to establish the target amount of the fund in a case person who is responsible for regular deposits dies before the target amount is reached.

### TECHNICAL FIELD

This invention pertains generally to the field of fund management related to internet computer communication network.

### BACKGROUND ART

People save money to prepare for the death, such as buying cemetery lot, paying for funeral expenses, leaving enough money behind for surviving family members to live on, etc. In order to lessen the financial burden related to the death, people buy life insurance. Often people buy a plan that combines a savings plan and a life insurance. People also buy health insurance.

With the advance of internet computer communication network, many private citizens possess their own web sites. Some of these private web sites might be maintained by descendants after the host dies, but most of those will be abandoned when the hosts of the private web sites become too sick to take care of the web sites, or die. In a way, such a private web site is as dear and meaningful as a grave. A private web site hold the images, writings, voices, etc., and keeping such a private web site alive could be more meaningful than maintaining the grave after a person dies. It is also important to make sure that the private web site is visited by people, especially by his descendants, long after the person dies. It would be nice if a person, an ordinary citizen with limited means, could be assured that he will be remembered and visited by descendants through his private web site he has left behind, for hundreds of years and beyond.

It costs money to maintain ‘a private web site whose host has been dead’ (We will call this sort of web site an ‘after-life web site’ in this patent application). A patent application on this subject is filed as a divisional patent application by the same applicant, namely me, under a title of “FUND MANAGEMENT SYSTEM AND METHOD FOR MAINTAINING A PRIVATE WEB SITE IN AUTO-PILOT MODE INDEFINITELY”.

As described there in detail, in order to maintain it indefinitely, over hundreds of years and even beyond, the web site should have a fund (We will call it ‘web-fund’) from which an income is generated, and the after-life web site is maintained using a part of the income (Some part of the income should be re-invested back to compensate the potential reduction in the value of the web-fund due to the monetary inflation). The size of a web-fund would be typically $10,000 to $20,000 if some rewards are to be dispensed to the people of the future, especially the descendants, so as to entice them to visit the after-life web site. For ordinary people it would not be easy to come up with the sum even if they would like to keep their private web sites alive after they die. This would be the case especially because the people who are interested in this after-life web plan would be old people, and most of them do not work for living and thus live on a limited fixed income.

### SUMMARY OF THE INVENTION

Accordingly, it is the primary objective of the present invention to devise means to prepare enough amount of a web-fund for a private web site so that the private web site is maintained successfully even after the host dies.

It is an accompanying objective of the present invention to devise means to save enough amount for the web-fund for making sure that a private web site will be visited by people, especially his descendants, even after the host of the private web site becomes too sick to take care of his own private web site, or even dies.

These objectives are achieved by setting up a savings plan with a purpose of saving the target amount for a web-fund. Many people who participate in such a savings plan would be old people, and might die before the target sum has been saved. Accordingly, this savings plan would preferably need an insurance policy built in the savings plan.

More details will be described below in conjunction with accompanying drawings and the claims.

### BRIEF DESCRIPTION OF DRAWINGS

FIG. 1 shows curves representing the cumulative total while a web-fund is saved over an extended period such as 10, 20, and 30 years.

FIG. 2 shows a curve of FIG. 1, in which a life insurance policy is incorporated to prepare for a premature death.

### DETAILED DESCRIPTION

This invention is related to a desire to maintain a private or family web site over hundreds of years and beyond using a private fund, that is, a web-fund, after the host of the private web sites dies. A patent application with this purpose is filed as a divisional patent application by the same applicant, namely me, under a title of “FUND MANAGEMENT SYSTEM AND METHOD FOR MAINTAINING A PRIVATE WEB SITE IN AUTO-PILOT MODE INDEFINITELY”.

It is not enough to maintain a private web site whose host is gravely ill or even dies (we call such a web site an “after-life web site”). It is preferred to establish incentives to draw in descendants'attention so that they visit the after-life web sites, even once per year. A key is then to establish enough fund, to be called a web-fund, for a after-life web site. In order to keep an after-life web site hundreds of years and even longer alive and well, the web-fund should not lose its value over time due to the monetary inflation. Accordingly, a part of the income stemming from the web-fund should be re-invested back into the web-fund to counter the inflation. Also, it would be preferred to limit the investment to a government-insured savings or investment plan since one cannot afford losing the value of the web-fund, and a loss could happen with other types of savings or investment. The drawback of such a government guaranteed savings or investment is that the income would be low, for example 5%. Assuming the inflation rate at 3%, only 2% of the 5% would be available to pay for the cost to run the after-life web site. Accordingly, the size of the web-fund could be at least $5,000, and preferably $10,000, or even more if rather a generous incentive plan is to be implemented for the afterlife web site. This amount of cash could be too large a sum for many people to come up with even if they would like to have after-life web sites of their own. In order to resolve this potential problem, a savings plan can be set up to allow the people to save, for example $10,000 in the year 2000 dollars (Since we are dealing with a long-term event, such as 10 to 30 years, it is convenient to discuss the money in the dollar value of a certain year. A sum of $10,000 in the year 2000 would have much more value than that of $10,000 in 2010 or 2030).

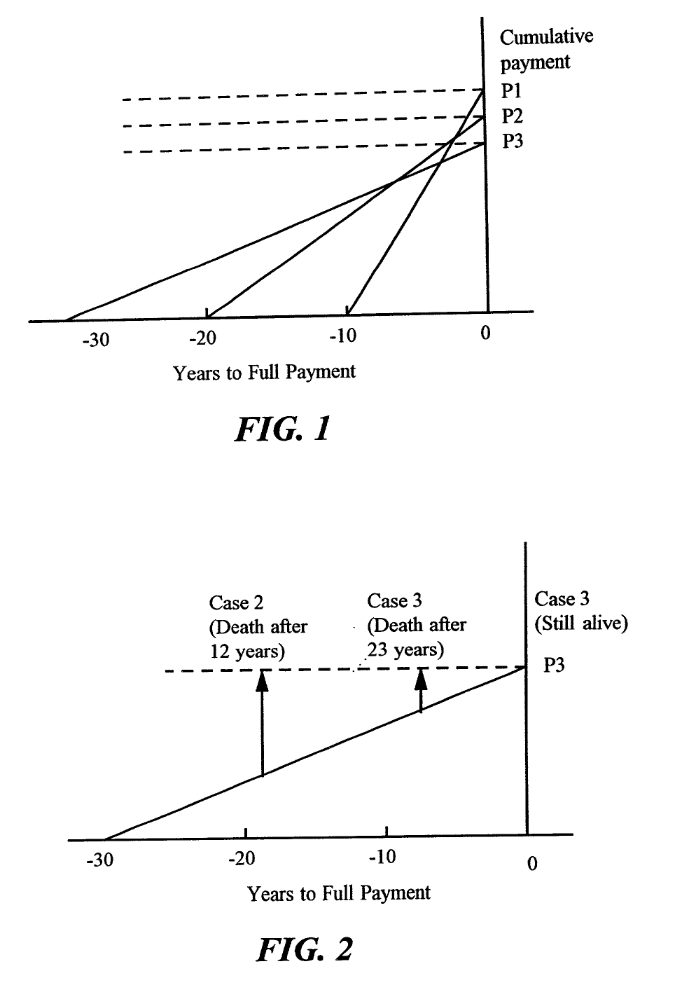

Referring to FIG. 1, people would deposit, for example, $10 per month over 30 years, depositing $3,600 (=P3) over the 30 years; or $18 per month over 20 years, depositing $4,320(=P2). (In FIG. 1 the years of the deposit are counted down to the year when the total target sum for the web-fund is reached, and thus shown as negative numbers). The amount P2 should be larger than P3 because the cumulative interest is less when the sum is deposited over a shorter period.

One complication that is bound to occur is the death of person who is responsible for the deposits (the person may or may not be the host of the private web site himself, and this distinction is immaterial in this patent application) before the 10, 20, or 30 year term is fulfilled. As shown in FIG. 12, a person could sign on a contract to deposit $10 per month over 30 years, and then dies 12 years later, or 23 years later. It is best that the total target sum P3 is dedicated to the private web site in this unfortunate case. In order to accommodate these unavoidable cases, the monthly deposit should be increased to include ‘the cost for buying a life insurance policy for this purpose’, that is, ‘a life insurance premium’. Then the monthly deposit could become $11 to $13 instead of $10 in this example (or $20 to $24 instead of $18 for the 20 year term), depending on the age of the person with the savings plan. These additional sum does not have to be differentiated when the deposit amount is presented to potential customers. It may be sufficient to explain that that the target sum is dedicated even in the case of a personal death. Nevertheless the amount of deposit should include the expense to cover such a personal death when the amount is calculated for business purpose.

It is assumed that the deposit sum would not be used until the person dies. If the person wants to keep a private web site of his own and further wants to dispense some monetary rewards through the web site while he lives, he should come up with that amount in addition to the deposits for the savings plan that is featured with the built-in insurance plan.

It would be natural and comforting to maintain the person's web site all along while he deposits the sum even when no rewards are dispensed while he lives. An extra expense, such as $1 or $2 per month, to keep the private web site could be added to the regular deposits.

Obviously many modifications and variations of the present invention are possible in light of the above teachings. It is therefore to be understood that within the scope of the appended claims the invention may be practiced otherwise than as specifically described.

1. A fund savings plan for an after-life web site, comprising
a web-fund of a certain amount,
deposits made on regular basis,
a private web site,
a host of the private web site,
wherein the web-fund is saved through the deposits over an extended period, the web-fund being needed to operate the private web site on the behalf of the host of the private web site after the host of the private web site dies, whereby the burden for establishing the web-fund is lessened.

2. An invention as in claim 1, wherein the web-fund is dedicated to the private web site even in a case that the savings plan is prematurely terminated due to the death of a person responsible for the regular deposit.

3. An invention as in claim 2, wherein the expense to cover the case of the personal death is explicitly itemized in calculating the amount of the deposit as a life insurance premium.

4. An invention as in claim 1, wherein the private web site is maintained while the host of the private web site is alive, and the cost to maintain the private web site while the host of the web site is alive is added to the amount of the regular deposit.

5. An invention as in claim 4, wherein the private web site dispenses monetary rewards to entice people to visit the private web site, and the cost to dispense the monetary rewards is added to the regular deposit.

6. A method for preparing a after-life web site, wherein a web-fund is saved through regular deposits over an extended period, the web-fund being needed to operate a private web site on the behalf of the host of the private web site after the host of the private web site dies, whereby the burden for establishing the web-fund is lessened.

7. An invention as in claim 6, wherein the web-fund is dedicated to the private web site even in a case that the savings plan is prematurely terminated due to the death of a person responsible for the regular deposit.
